(19) United States
(12) Patent Application Publication
(10) Pub. No.: US 2026/0346840 A1
(43) Pub. Date: Nov. 5, 2026

(54) INFORMATION CONVERSION SYSTEM, INFORMATION CONVERSION METHOD, AND STORAGE MEDIUM

(71) Applicant: TOYOTA JIDOSHA KABUSHIKI KAISHA, Toyota-shi (JP)

(72) Inventors: Yoshiki UEDA, Nagakute-shi (JP); Osamu TANIAI, Okazaki-shi (JP); Shiro ODA, Anjo-shi (JP)

(73) Assignee: TOYOTA JIDOSHA KABUSHIKI KAISHA, Toyota-shi (JP)

(21) Appl. No.: 19/529,659

(22) Filed: Feb. 4, 2026

(30) Foreign Application Priority Data
May 2, 2025 (JP) 2025-076546

(51) Int. Cl. B60W 30/10

(52) U.S. Cl. CPC B60W 30/10

(57) ABSTRACT

An information conversion system according to the present disclosure inputs an input attribute that is an attribute of a waypoint described in natural language to a trained model incorporating a large language model (LLM), the waypoint being a candidate for a via point of an autonomous mobile robot that travels in a facility. The information conversion system recognizes, by the trained model, attribute information indicated by the input attribute among a plurality of types of attribute information indicating the attribute of the waypoint, and outputs an action of the autonomous mobile robot from the waypoint to an adjacent waypoint that is adjacent to the waypoint, the action corresponding to the attribute information that is recognized.

### CROSS-REFERENCE TO RELATED APPLICATION

This application claims priority to Japanese Patent Application No. 2025-076546 filed on May 2, 2025. The disclosure of the above-identified application, including the specification, drawings, and claims, is incorporated by reference herein in its entirety.

### BACKGROUND

### 1. TECHNICAL FIELD

The present disclosure relates to an information conversion system, an information conversion method, and a storage medium.

### 2. DESCRIPTION OF RELATED ART

Japanese Unexamined Patent Application Publication No. 2023-064983 (JP 2023-064983 A) discloses a technique of setting a waypoint in a virtual space in which a virtual model of a facility to be toured by an autonomous mobile object is disposed, based on an instruction from a user. In this technique, a command representing a work content or a processing content performed by the autonomous mobile object is assigned to each waypoint to be toured in a case of generating a touring route of the autonomous mobile object.

### SUMMARY

It is desired to develop a technique that can designate an action at a waypoint even when an attribute of the waypoint is described and input in different expressions for each user. The technique disclosed in JP 2023-064983 A does not enable such designation.

An information conversion system according to the present disclosure is an information conversion system, in which the information conversion system is configured to input an input attribute that is an attribute of a waypoint described in natural language to a trained model incorporating a large language model, the waypoint being a candidate for a via point of an autonomous mobile robot that travels in a facility, and recognize, by the trained model, attribute information indicated by the input attribute among a plurality of types of attribute information indicating the attribute of the waypoint, and output an action of the autonomous mobile robot from the waypoint to an adjacent waypoint that is adjacent to the waypoint, the action corresponding to the attribute information that is recognized.

An information conversion method according to the present disclosure is an information conversion method that is executed by a computer, the information conversion method including:
inputting an input attribute that is an attribute of a waypoint described in natural language to a trained model incorporating a large language model, the waypoint being a candidate for a via point of an autonomous mobile robot that travels in a facility; and recognizing, by the trained model, attribute information indicated by the input attribute among a plurality of types of attribute information indicating the attribute of the waypoint, and obtaining an action of the autonomous mobile robot from the waypoint to an adjacent waypoint that is adjacent to the waypoint, the action corresponding to the attribute information that is recognized.

A storage medium according to the present disclosure stores a program that causes a computer to execute:
inputting an input attribute that is an attribute of a waypoint described in natural language to a trained model incorporating a large language model, the waypoint being a candidate for a via point of an autonomous mobile robot that travels in a facility; and recognizing, by the trained model, attribute information indicated by the input attribute among a plurality of types of attribute information indicating the attribute of the waypoint, and obtaining an action of the autonomous mobile robot from the waypoint to an adjacent waypoint that is adjacent to the waypoint, the action corresponding to the attribute information that is recognized.

According to the present disclosure, it is possible to designate an action at a waypoint even when the attribute of the waypoint is described and input in different expressions for each user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a configuration example of a management system that uses map data generated by an information conversion system according to an embodiment;

FIG. 2 is a block diagram showing a configuration example of the information conversion system according to the embodiment;

FIG. 3 is a diagram showing an example of a table showing a correspondence between a waypoint attribute and an action;

FIG. 4 is a schematic diagram showing an example of map data of one floor of a facility input to the information conversion system of FIG. 2;

FIG. 5 is a schematic diagram showing an example in which a waypoint with an action is disposed in the map data of FIG. 4 in the information conversion system of FIG. 2; and

FIG. 6 is a flowchart for describing an example of the information conversion method according to the embodiment.

### DETAILED DESCRIPTION OF EMBODIMENTS

Hereinafter, the present disclosure will be described through an embodiment of the present disclosure, but the disclosure according to the claims is not limited to the following embodiment. In addition, all of the configurations described in the embodiment are not always needed as means for solving the problem.

### Embodiment

The information conversion system (hereinafter, the present system) according to the present embodiment is a system that outputs an action for a waypoint set in map data. In the present system, corrected map data that is map data in which the action has been set in the waypoint may be output for the map data. That is, the present system can be incorporated into a map correction system that corrects the map data. The corrected map data can be used, for example, in a management system for managing an autonomous mobile object, in other words, an autonomous mobile robot, as described below.

### Schematic Configuration Example of Management System

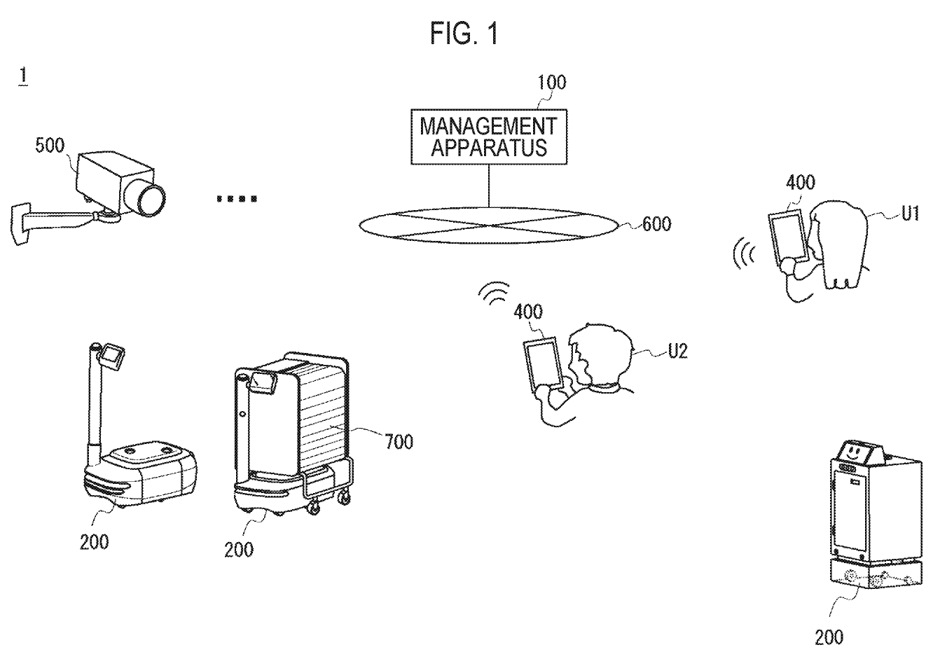

FIG. 1 is a schematic diagram showing a configuration of a management system 1. The management system 1 includes a management apparatus 100, a robot 200, a camera 500, a network 600, a user terminal 400, and an accessory unit 700. The management system 1 is a system for managing one or a plurality of robots 200. The management apparatus 100 manages passage or a task of one or a plurality of robots 200.

The robot 200 is an autonomous mobile object that executes a task such as a transport task. The robot 200 autonomously moves in a health-care facility such as a hospital, a rehabilitation center, a nursing-care facility, and a senior residential facility. The robot 200 is used for transporting medicines, medical devices, meals, tableware, medical records, supplies, specimens, linens, people, and the like. The transport target may be a person such as a patient. In addition, the management system 1 can also be used in a commercial facility such as a shopping mall. The robot 200 includes wheels, a vehicle frame, a motor, a sensor, a battery, a controller, and the like. At least one of the robots 200 is a robot of a different type. All of the robots 200 may be robots of the same type. Each of the robots 200 is assigned a unique identification number (ID). In FIG. 1, three robots 200 are shown, but the number of robots is not particularly limited as long as it is one or more.

Further, at least one of the robots 200 may execute a task other than the transport task. Examples of the other tasks include a cleaning task, a security task, and a guidance task. The robot 200 may execute a plurality of tasks such as cleaning, security, and guidance using the accessory unit 700, or may execute a task alone. For example, the robot 200 executes various tasks by using the accessory unit 700 in combination with the robot 200. An accessory unit different depending on the task may be prepared for the robot 200. By replacing the accessory unit 700, the robot 200 is a multitask robot that executes a plurality of tasks.

In a case of the transport task, the accessory unit 700 is a cart or a wagon with wheels on which a transport object is mounted. In a case of the cleaning task, the accessory unit 700 has a vacuum cleaner that sucks up garbage or the like, although it is different from the one shown. In a case of the security task, the accessory unit 700 is different from the one shown, but has a sensor such as a LiDAR (registered trademark, hereinafter, the same applies) or a camera. In the following description, the robot 200 will be mainly described as executing the transport task.

The user U1 or the user U2 can make a task request such as a transport request of the transport object using the user terminal 400. For example, the user terminal 400 is a tablet computer, a smartphone, or the like. The user terminal 400 may be an information processing apparatus that can communicate in a wireless or wired manner.

The robot 200 and the user terminal 400 are connected to the management apparatus 100 via the network 600. The network 600 is a wired or wireless local area network (LAN) or wide area network (WAN). Further, the management apparatus 100 is connected to the network 600 in a wired or wireless manner. For communication between the devices, for example, a general-purpose communication standard such as Wi-Fi (registered trademark) can be used.

Various signals transmitted from the user terminals 400 of the users U1 and U2 are temporarily sent to the management apparatus 100 via the network 600, and are transmitted to the robot 200 as a target from the management apparatus 100. Similarly, various signals transmitted from the robot 200 are temporarily sent to the management apparatus 100 via the network 600, and are transmitted to the user terminal 400 as a target from the management apparatus 100. The management apparatus 100 is a server connected to each device, and collects data from each device. In addition, the management apparatus 100 is not limited to a single physical apparatus, and may have a plurality of apparatuses that perform distributed processing. In addition, the management apparatus 100 may be disposed in a distributed manner in an edge device such as the robot 200. For example, a part or all of the management system 1 may be mounted on the robot 200.

The robot 200 includes a drive motor, wheels, a battery, and the like. Further, the robot 200 includes a sensor such as a camera or a LiDAR, and a calculation processing unit such as a processor. The robot 200 estimates a self-position based on a detection result of the sensor. The robot 200 autonomously moves along a route from a departure area to a destination on the map based on the self-position. The departure area is a current position of the robot, and the destination is a transport destination of the transport object. In addition, a route search may be performed via a transport source of the transport object or the like as a via point. The management apparatus 100 may perform the route search from the departure area to the destination, or the robot 200 may perform the route search.

The user terminal 400 and the robot 200 may transmit and receive signals without using the management apparatus 100. For example, the user terminal 400 and the robot 200 may directly transmit and receive signals by wireless communication. In addition, the management apparatus 100 may collect data from the camera 500. The camera 500 is a surveillance camera, a security camera, or the like. Further, the management apparatus 100 may collect data from a communication device or a sensor (not shown).

It is assumed that a plurality of types of robots 200 are used in the facility. The management apparatus 100 assigns the task to each of the robots 200. Each of the robots 200 may execute the assigned task by mounting the accessory unit 700 corresponding to the assigned task. The tasks executed by each of the three robots 200 may be input by the user U1 or the user U2, or may be scheduled in advance. For example, the user U1 or the like performs the task request by operating the user terminal 400. The user U1 or the like can input a type of the task to be executed. The user U1 or the like may input a region or a time slot in which the task is executed. The management apparatus 100 creates a schedule for the robot 200 to efficiently execute the task.

The user U1 or the user U2 may request the transport task by operating the user terminal 400. In this case, the user U1 or the user U2 inputs information related to the transport object. Further, the user U1 or the user U2 may input scheduled arrival information indicating an arrival schedule of the transport object. The management apparatus 100 assigns the robot that executes the transport task based on the scheduled arrival information. Then, the management apparatus 100 transmits a control signal for the robot to execute the task. The control signal may include transport object information indicating a route to the destination or the transport object.

In such an overall configuration, each element of the management system 1 can be distributed to the robot 200, the user terminal 400, and the management apparatus 100 to construct the management system 1 as a whole. In addition, a substantial element for realizing the transport of the transport object can be collected in one apparatus to be constructed.

The management apparatus 100 includes a server computer or the like, and performs calculation for controlling and managing the robot 200. The management apparatus 100 can be implemented as, for example, a device including a processor such as a central processing unit (CPU) of a computer, a memory, and the like, and executing a program. The functions described below can also be realized by a program. The management apparatus 100 manages each of the robots 200 based on the map data stored in the management apparatus 100, a transport object ID of the transport object, and a robot ID of the robot 200. The map data refers to corrected map data 12c described below, and is referred to as corrected map data below.

For example, the management apparatus 100 manages the schedules of the robots 200 such that the robot 200 can efficiently execute the task. For example, when the management apparatus 100 receives the task request from the user terminal 400 or the like, the management apparatus 100 selects one robot 200 from the robots 200 and issues an instruction to the robot 200 to execute the task. Alternatively, the management apparatus 100 issues an instruction to the robot 200 to use the accessory unit 700.

In the corrected map data used in the management system 1, for example, a waypoint associated with a position or an area on the map is set. An attribute may be set for the waypoint. In the corrected map data or at least a part of the waypoint, an action taken by the mobile object is set according to the waypoint or the attribute of the waypoint, but passage availability or priority of the mobile object may also be set as passage classification information. Examples of the waypoint and the action will be described below.

The corrected map data is data of a map indicating a floor map (referred to as a map) of the facility. The corrected map data may include information related to a travel restriction area or the like that is different from the information related to the waypoint or is associated with the attribute of the waypoint. In addition, the corrected map data may be data of a map including a partial region in which a service is scheduled to be executed, instead of the floor map of an entirety of the facility, and in this case, the map data before the correction may include data showing a partial region. Each robot 200 autonomously drives to the destination with reference to the corrected map data.

The corrected map data is data that is corrected by the map correction system incorporated into the present system. The map data before the correction may be generated based on, for example, building data such as architectural drawing data of the facility, image data acquired by a camera installed inside the facility, and measurement result data of a distance measurement sensor, or data obtained by combining a plurality of the data. In addition, the corrected map data may be data in the same format as the map data before the correction, or may be data converted into a different format.

The architectural drawing data described above may be image data obtained by reading an architectural drawing on a paper medium, or may be image data obtained by converting CAD data, BIM data, or the data into a PDF (registered trademark). CAD is an abbreviation for Computer-Aided Design. BIM is an abbreviation for Building Information Modeling. PDF is an abbreviation for Portable Document Format. The architectural drawing data is, for example, two-dimensional architectural drawing data, but may be three-dimensional architectural drawing data.

The measurement result data of the distance measurement sensor described above is an example of image data acquired by the robot 200 or another robot or person equipped with the sensor moving inside the facility, that is, inside the building. The distance measurement sensor can be, for example, a LiDAR sensor, a depth sensor, a stereo camera, a radar, or a combination of a plurality of the sensors. The map data 12a may be generated based on the data of the various sensors using the existing technology, regardless of an integration method of the data of the various sensors included in the distance measurement sensor. The map data 12a before the correction is not limited to two-dimensional map data, and may be three-dimensional map data.

The measurement result data serving as a basis for the map data before the correction refers to, for example, when the distance measurement sensor is LiDAR, point cloud data obtained by measuring the inside of the facility by moving a mobile object including the LiDAR sensor in the facility, that is, two-dimensional point cloud data or three-dimensional point cloud data acquired using the LiDAR. The mobile object may be an autonomous mobile object as the robot 200 to be managed by the management apparatus 100, may be another type of autonomous mobile object, or may be a mobile object that moves by being pushed or remotely operated. Regardless of whether the mobile object is an autonomous mobile object or is moved by being pushed, the actual position of each acquired measurement point can be specified because the moving distance and the moving direction can be understood by equipping the tire attached to the mobile object with a gear, a sensor that detects the direction, or the like. In addition, the LiDAR sensor is, for example, a two-dimensional LiDAR sensor. In this case, the map data 12a is obtained as two-dimensional point cloud data, that is, point cloud data on a measurement plane. However, as described above, the map data 12a may be three-dimensional map data, and may be, for example, three-dimensional point cloud data in a three-dimensional space acquired by a three-dimensional LiDAR sensor. The mobile object may be a mobile object in which the same model sensor as the LiDAR sensor provided in the autonomous mobile object such as the robot 200 to be operated in the facility is installed under the same installation condition as the autonomous mobile robot, as the LiDAR sensor. The same installation condition can be, for example, the same height, the same direction, and the same number of the installed sensors. As a result, the corrected map data 12c having a height or the like that matches the distance measurement data during operation of the autonomous mobile object to be operated, such as the robot 200, can be obtained.

### Configuration Example of System

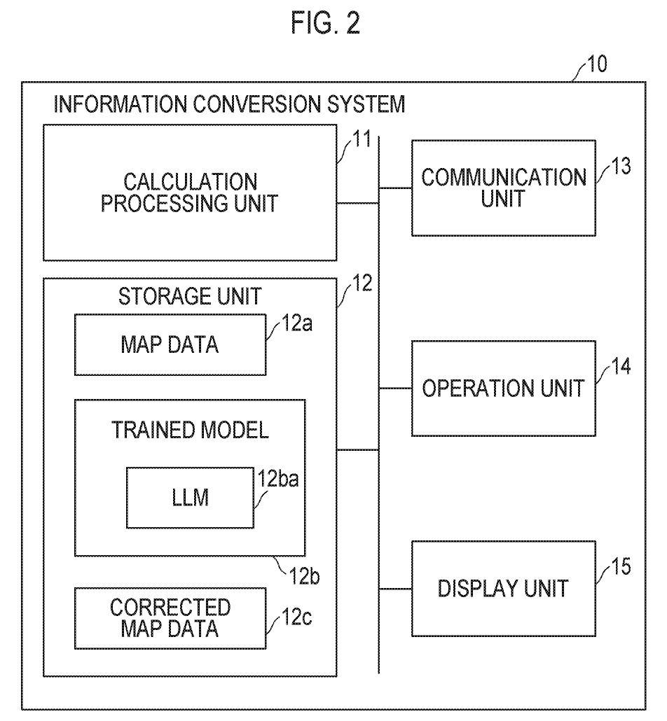

The present system as described above will be described with reference to FIG. 2. FIG. 2 is a block diagram showing an information conversion system 10 that is a configuration example of the present system.

The information conversion system 10 can be configured by a computer. The information conversion system 10 can include, for example, a calculation processing unit 11 configured by a processor such as a CPU and a memory, a storage unit 12 configured by a storage device, a communication unit 13 that communicates with the outside, an operation unit 14 that receives a user operation, and a display unit 15 that displays information. The calculation processing unit 11 may realize functions related to information conversion and map correction described below by executing a program. The communication unit 13 includes a communication interface. The operation unit 14 receives an input operation of information such as an input attribute described below, a designation operation of the map data 12a, a correction instruction operation, and the like as the user operation. The information input operation and the correction instruction operation correspond to an operation of inputting a request. The information conversion system 10 can also be constructed as a distributed system in which some functions are distributed to a plurality of apparatuses.

The storage unit 12 stores a trained model 12b in a state in which the trained model 12b is accessible from the calculation processing unit 11. The trained model 12b is an example of a trained model incorporating a large language model (LLM) 12ba. The LLM 12ba may be generative AI (Artificial Intelligence) such as ChatGPT (registered trademark), LaMDA, and BERT, but the present disclosure is not limited thereto, and the type of the LLM 12ba is not limited. LaMDA is an abbreviation for Language Model for Dialogue Applications, and BERT is an abbreviation for Bidirectional Encoder Representations from Transformers. When the trained model 12b includes a machine learning model other than the LLM 12ba, the model can be, for example, a model that performs post-processing of the LLM 12ba, and the algorithm or the like thereof may be any algorithm capable of carrying out processing in response to the request in cooperation with the LLM 12ba.

In the information conversion system 10, the calculation processing unit 11 inputs an input attribute that is an attribute of a waypoint described in natural language to the trained model 12b in which the LLM 12ba is incorporated. The waypoint is a candidate for a via point of an autonomous mobile robot that travels in the facility. The input attribute is information input as a part or all of the request, and is input by the user using the operation unit 14, but may be selected by the user from among a plurality of types of requests prepared in advance.

The input attribute may be designated and input on the map data 12a stored in the storage unit 12 or the like by designating one or a plurality of waypoints. Alternatively, the input attribute may be designated and input for each feature of the position of the waypoint. The feature of the position may be input, for example, by designating a main structural part of the facility and a structure other than the main structural part. Here, the main structural part can be, for example, a wall, a column, a floor, a beam, a roof, a staircase, or the like, and refers to a main part of the internal structure of the facility. The structure other than the main structural part refers to, for example, building materials such as a door of a room and an emergency door, and an installed object. However, the main structural part and the structure other than the main structural part are not limited to the examples, and may be defined in advance. The structure is not limited to a part of the internal structure of the facility, and may include an object installed after the construction of the facility, that is, an existent object installed during operation of the facility. The existent object refers to, for example, furniture, a handrail, a cushion, or the like.

In addition, the natural language may include a plurality of individual languages. That is, the LLM 12ba can correspond to a plurality of individual languages. In the following description, the robot 200 will be described as an example of the autonomous mobile robot.

Next, in the information conversion system 10, the calculation processing unit 11 executes calculation mainly in the LLM 12ba of the trained model 12b to recognize the attribute information indicated by the input attribute among the types of attribute information indicating the attribute of the waypoint. The LLM 12ba may be trained on natural language for various types of attribute information.

In the information conversion system 10, the calculation processing unit 11 executes calculation mainly in the LLM 12ba of the trained model 12b to output the action of the robot 200 from the waypoint to the waypoint adjacent to the waypoint, corresponding to the recognized attribute information. It goes without saying that the adjacent waypoint is also a candidate for a via point of the robot 200. Here, when setting each waypoint in map data 12a, the attribute information may also be associated with each waypoint and output such that the attribute information can be assigned to each waypoint, but outputting actions associated with each waypoint may be sufficient. For convenience, the calculation in the trained model 12b is divided into the calculation in the LLM 12ba and the calculation in the subsequent stage, but the calculation may be performed simultaneously.

In particular, the calculation processing unit 11 may output the action of the robot 200 from the waypoint to the next waypoint on the traveling route, corresponding to the attribute information recognized as indicated by the input attribute, by executing the calculation in the trained model 12b. The example is useful when the traveling route of the robot 200 is known in advance because an action suitable for the traveling route can be output. In this case, when the traveling routes are different, different actions can be set for the same waypoint.

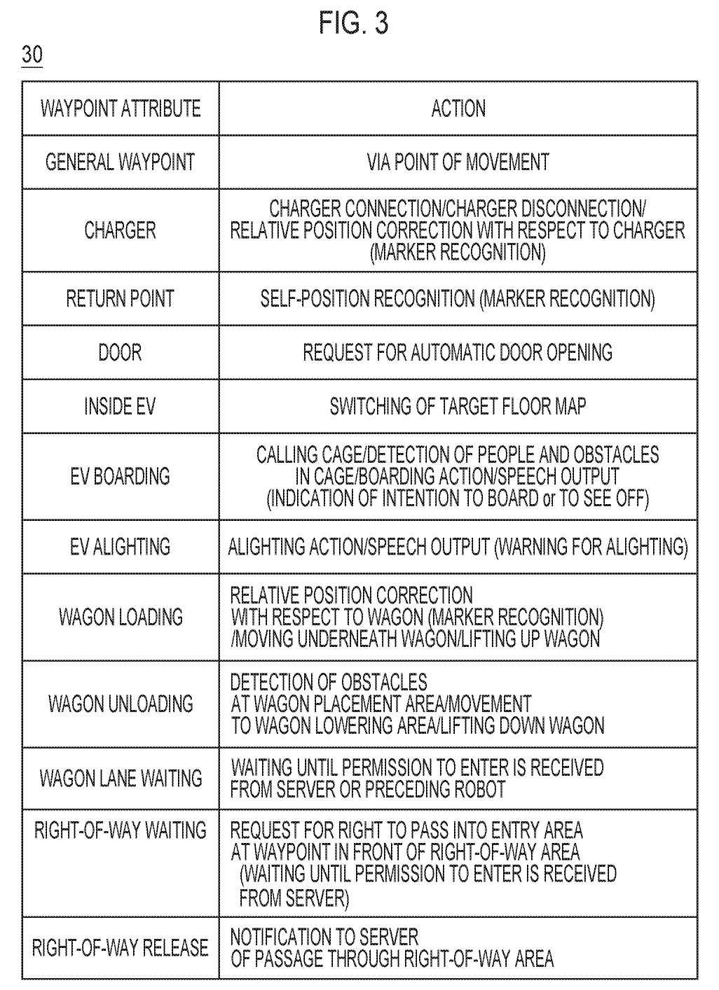

Here, an example of a correspondence between information indicating attribute information that is an attribute of the waypoint, that is, a waypoint attribute (hereinafter, WP attribute) and the action will be described with reference to FIG. 3. FIG. 3 is a diagram showing an example of a table showing the correspondence between the WP attribute and the action.

The action is output according to the type of the attribute information recognized as the information of the WP attribute. The waypoint can be said to be a point at which the action of the robot 200 is determined. A table 30 shown in FIG. 3 is a table describing a correspondence between the WP attribute for the waypoint and the action taken at the waypoint during operation in the management system 1. It is preferable that the table as in the table 30 is stored in the storage unit 12 such that the trained model 12b implicitly includes the table or the trained model 12b can refer to the table as other information. As shown in the table 30, the WP attribute can include, for example, attributes such as a general waypoint, a charger, a return point, a door, inside an EV, an EV boarding, an EV alighting, a wagon loading, a wagon unloading, a wagon lane waiting, right-of-way waiting, and right-of-way release. Two or more attributes may correspond to one waypoint. Specifically, one or more other attributes may correspond to the general WP attribute. That is, the attribute information can be said to be information indicating an attribute associated with one or a plurality of actions that can be taken as the action. That is, the attribute information can be said to be information for distinguishing the action. Examples of the action include, in addition to simple continuation of movement, that is, via, grant of passage right, automatic door authentication, and elevator call.

The general waypoint is a waypoint indicating a via point of movement. The via point can be a departure point or an arrival point. Examples of the candidate for the waypoint include a vicinity of a door, a vicinity of a narrow passage, and a vicinity of an elevator, but the present disclosure is not limited thereto. The general waypoint has a role as a via point of movement in route planning. The robot 200 autonomously moves through the general waypoint toward the next waypoint. For example, the trained model 12b can overwrite or add the action corresponding to the WP attribute by recognizing the other WP attributes shown in the table 30 after recognizing each waypoint as the general waypoint. The WP attribute may be an attribute corresponding to the layout or the type of the surrounding room, and in this case, the user merely needs to input the disposition or the type of the surrounding room as the input attribute.

Hereinafter, the setting of the WP attribute and the adopted action will be described, but the setting of the WP attribute refers to the recognition of the WP attribute in the trained model 12b, and the adoptable action refers to the output action.

When the charger is set as the WP attribute, any of charger connection, charger disconnection, or relative position correction with the charger by recognizing a marker written on the charger can be adopted as the action. For example, when the battery remaining amount of the robot 200 is equal to or less than a certain value, the robot 200 moves to the waypoint of the charger as the destination. When the robot 200 arrives at the waypoint of the charger, the robot 200 performs the relative position correction. For example, the charger is marked, and the camera of the robot 200 images the marker to perform the relative position correction. Then, the robot 200 is connected to the charger to perform charging. When the charging is completed, the robot 200 performs the charger disconnection. The following WP attributes will be described more concisely.

When the return point is set as the WP attribute, an action of recognizing the self-position of the robot 200 by a marker written at various positions in the facility can be adopted. When the door is set as the WP attribute, an action of making a request to open the automatic door can be adopted. When the inside of the EV is set as the WP attribute, an action of switching the floor map to be the destination to the map in the elevator (EV) can be adopted. When the boarding of the EV is set as the WP attribute, any of an action of calling a cage of the EV, an action of detecting a person or an obstacle in the cage, an action of boarding, or an action of voice notification indicating intent to board or to alight can be adopted as the action. When the alighting from the EV is set as the WP attribute, any of an alighting action or utterance for a warning for alighting can be adopted as the action. When the wagon loading is set as the WP attribute, any of relative position correction with the wagon by recognizing a marker written on the wagon, moving underneath the wagon, or lifting up the wagon can be adopted as the action. When the wagon unloading is set as the WP attribute, any of obstacle detection in a wagon placement area, movement to a wagon unloading position, or lifting down of the wagon can be adopted as the action. When the wagon lane waiting is set as the WP attribute, an action of waiting until an access permission from the management apparatus 100 or the preceding robot 200, which is a server, is received can be adopted. When the right-of-way waiting is set as the WP attribute, an action of requesting the right to pass into an entry area at the waypoint in front of the right-of-way area and waiting until the access permission from the server is received can be adopted. When the right-of-way release is set as the WP attribute, an action of notifying the server that the right-of-way area is passed can be adopted.

When the request including the input attribute is input, the calculation processing unit 11 inputs the request to the LLM 12ba of the trained model 12b, and can obtain the action corresponding to the recognized attribute information as an output result from the LLM 12ba or as an output result to the subsequent stage, as shown in the table 30.

In addition, the calculation processing unit 11 may input the direction information indicating the traveling direction of the robot 200 to the trained model 12b by reading out the direction information as a part of the request or the information stored in advance. As described above, the direction information may be described in natural language or need not be described in natural language, and for example, information indicating the traveling direction of the robot 200 may be read out when the traveling direction of the robot 200 is determined. In this case, the trained model 12b may determine the adjacent waypoint in accordance with the direction information. In other words, training the trained model 12b by machine learning to make such determinations suffices.

Alternatively, the calculation processing unit 11 may input the route information indicating the traveling route in the robot 200 to the trained model 12b by reading out the route information as a part of the request or the information stored in advance. As described above, the route information may be described in natural language or need not be described in natural language, and for example, information indicating the traveling route of the robot 200 may be read out when the traveling route of the robot 200 is determined. In this case, the trained model 12b may determine the adjacent waypoint in accordance with the route information. In other words, training the trained model 12b by machine learning to make such determinations suffices.

The trained model 12b can determine which waypoint corresponds to the adjacent waypoint, that is, which point is the next waypoint, in accordance with the direction information or the route information by corresponding to any of the direction information or the route information. Then, the trained model 12b can also output different actions in accordance with the determination. As a result, the trained model 12b can obtain different outputs, for example, making the action different between a convergence side and a branch side of a three-way intersection, and making the action different between a case of facing a dead end direction and a case of escaping from a dead end region.

Next, an example in which the information conversion system 10 also corrects the map data 12a stored in the storage unit 12 based on the action obtained in this way will be described.

In the information conversion system 10, the calculation processing unit 11 inputs the map data 12a corresponding to the map data before the correction described above to the trained model 12b. Hereinafter, the description will be made on the premise that the calculation processing unit 11 reads out the map data 12a stored in the storage unit 12 as the input target. In order to do so, the calculation processing unit 11 may acquire the map data 12a from a device such as an external server via the communication unit 13 and store the map data 12a in the storage unit 12, or may acquire the map data 12a from an external storage device via an interface (not shown) and store the map data 12a in the storage unit 12. The storage unit 12 merely needs to store the map data 12a in a state in which the map data 12a is accessible from the calculation processing unit 11. The storage of the map data 12a may be temporary. In this case, the input of the map data 12a substantially means the acquisition of the map data 12a from the outside.

In order to correct the map data 12a, the trained model 12b can include a vision-language model (VLM) as an example of the machine learning model to be incorporated in addition to the LLM 12ba. The VLM is a model that outputs at least one of image data or language data as an output with image data and language data as an input. The VLM may be generative AI such as ChatGPT (registered trademark), but the present disclosure is not limited thereto, and the type of the VLM is not limited. When the trained model 12b includes a machine learning model other than the LLM 12ba and the VLM, the model can be, for example, a model that performs intermediate processing or post-processing of the VLM, and the algorithm or the like thereof may be any algorithm capable of carrying out processing in response to the request in cooperation with the LLM 12ba and the VLM.

As described above, the calculation processing unit 11 of the information conversion system 10 inputs the map data 12a of the facility in addition to the input attribute to the trained model 12b.

The map data 12a as the input target can include information indicating a plurality of divided areas obtained by dividing an area indicated by the map data 12a into a plurality of areas based on the main structural part of the facility and the structure other than the main structural part. As described above, the map data 12a may already be divided into the divided areas, or may be data before the division. The trained model 12b may be generated by machine learning in accordance with the map data 12a as the input target.

The trained model 12b sets the waypoint corresponding to the attribute information indicated by the input attribute for at least one divided area of the divided areas of the map data 12a, and sets the action corresponding to the attribute information for the waypoint. In this case, the attribute information may be assigned to the waypoint, and the action may be associated with the attribute information. The attribute of the waypoint can also be referred to as a type of the waypoint.

The calculation processing unit 11 executes the calculation in the trained model 12b in this way to output the corrected map data 12c in which the waypoint and the action are set to the output destination. The corrected map data 12c may be in a format different from the map data 12a. For example, when the map data 12a is point cloud data, the corrected map data 12c may be in the same format, or may be line-drawing data obtained by performing smoothing processing on the point cloud data.

The output destination of the corrected map data 12c may be the storage unit 12. FIG. 2 shows a state in which the corrected map data 12c is output to the storage unit 12 and stored. The corrected map data 12c may be temporarily stored in the storage unit 12 for transmission to the outside. In addition, the calculation processing unit 11 can also display the corrected map data 12c on the display unit 15, and the output destination in this case is the display unit 15.

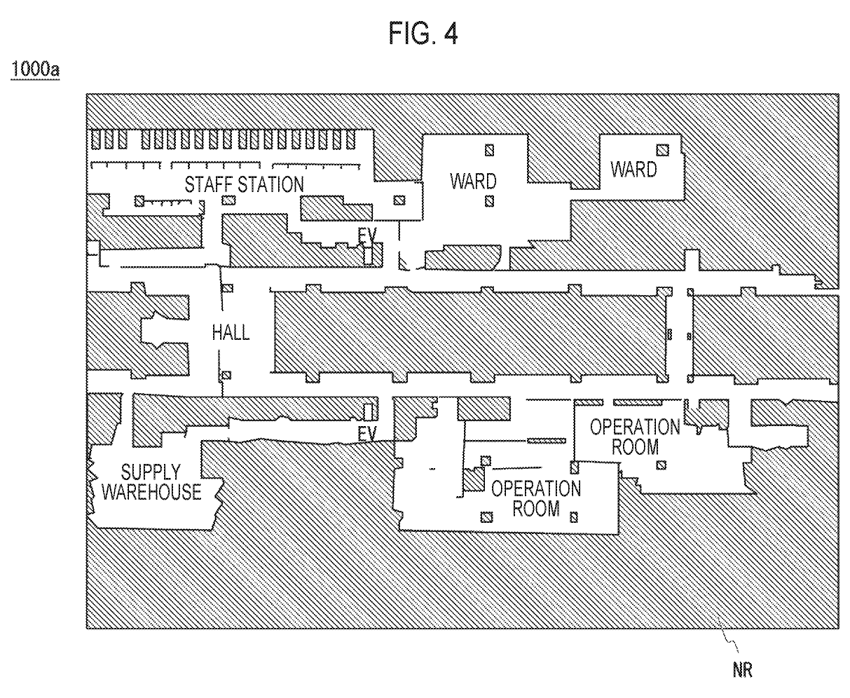

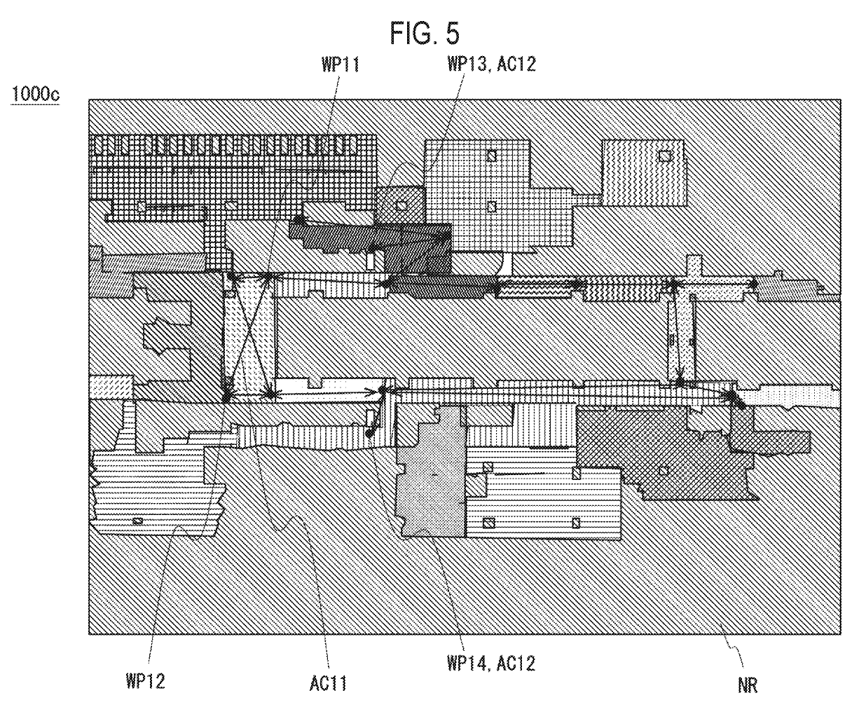

Next, a correction example of the map data 12a in the information conversion system 10, that is, an example of generating the corrected map data 12c will be described with reference to FIGS. 4 and 5. FIG. 4 is a schematic diagram showing an example of map data of one floor of a facility input to the information conversion system 10. FIG. 5 is a schematic diagram showing an example in which a waypoint with an action is disposed in the map data of FIG. 4. In the map data 1000a shown in FIG. 4 and the corrected map data 1000c shown in FIG. 5, a hatched region indicated by a region NR refers to a structural body or an in-wall space, and refers to a space in which the movement of the robot 200 is not assumed or a concrete structure. When there are a plurality of floors of the facility, since the processing is performed for each floor, and the corrected map data 12c is output, one floor will be described below.

The map data 1000a shown in FIG. 4 is map data indicating a certain floor in a hospital as an example of the facility, and is an example of the map data 12a. As shown in the map data 1000a, in addition to a room such as a staff station or a ward, an elevator EV and the like are present as a structure, and an installed object such as a table or a shelf is also present in the floor.

In the trained model 12b, the waypoint and the action are set for at least one divided area of the divided areas of the map data 1000a input to the trained model 12b or the VLM included in the trained model 12b based on the attribute information indicated by the input attribute. The divided area is an area obtained by dividing the area indicated by the map data 1000a into a plurality of areas based on the main structural part of the facility and the structure other than the main structural part. In the corrected map data 1000c of FIG. 5, each divided area obtained by the division is shown as a difference in hatching. The division may be executed before the input to the trained model 12b, or may be executed by the trained model 12b. The waypoint may be set at a predetermined position of each divided area, for example, the center of the area, the boundary with the adjacent area, or the like, based on the attribute information.

Here, an example will be described in which a request to assign the general waypoint to the four corners of the hall or the position of the column in the passage and a request to assign the waypoint of the EV boarding are included in the request including the input attribute. The trained model 12b can recognize that the EV boarding is a point in front of the elevator even when the feature of the waypoint is not particularly described.

The trained model 12b sets the waypoint at the target point for the general waypoint and associates the action as the via point of the movement, and associates the action as shown in the table 30 corresponding to the EV boarding such as the cage call in front of the elevator in response to the request. Then, the calculation processing unit 11 sets the waypoint with the action in the map data 1000a, and outputs the corrected map data 1000c as a result to the output destination.

In the corrected map data 1000c to be output, the general waypoint is set at a position indicated by the points such as the waypoints WP11, WP12, and the action AC11 indicating the movement between the adjacent waypoints is set. In FIG. 5, the action indicated by the bidirectional arrow is set at the waypoint on the start point side of the arrow. In addition, in thecorrected map data 1000c, the waypoints WP13, WP14 are set in front of the elevator, and the action AC12 such as the cage call is set as the action thereof.

As described above, the map data generated by correcting the map data 1000a by inputting the map data 1000a and the request is the corrected map data 1000c to be exemplified. However, the corrected map data 1000c to be output may be data after the information of the divided area is removed, or may be data after unnecessary information such as an unnecessary line or an unnecessary character such as a staff station is deleted.

Here, the area division for assigning the information indicating the divided area will be described. The area division can be divided by a segmentation algorithm such as a Voronoi partitioning algorithm. That is, the divided area may be an area divided by such a segmentation algorithm. In this case, the calculation processing unit 11 executes the segmentation processing in the trained model 12b to execute the division into the divided areas, or executes the division into the divided areas in the segmentation algorithm provided in the front stage of the VLM. In addition, the segmentation algorithm may be a learning model that has been trained by machine learning using, as training data, a result of executing the area division on various building data.

Here, learning processing of generating the trained model 12b including the VLM will be briefly supplemented. The VLM can be generated by using the existing technology to handle image data such as the map data 12a and text data in the same coordinate space and performing machine learning. In addition, the trained model 12b can be generated to include, for example, an extraction model that extracts the main structural part and the other structure from the map data 12a. The extraction model may perform machine learning to extract the main structural part and the other structure related to the input attribute indicated by the request from the map data 12a before or after the area division, and extract the waypoint corresponding to the attribute information indicated by the input attribute. The extraction model may include the segmentation algorithm to be able to correspond to the map data 12a before the area division.

In addition, the extraction model can be generated to correspond to the extraction of the type of the divided area using the name or the abbreviation for the main structural part and the other structure. In practice, the map data 12a may include a character or a symbol indicating each structure inside as in the map data 1000a of FIG. 4 when the map data 12a is the architectural drawing data. Even when the architectural drawing data includes no such character or symbol, the character or the symbol can be added as the text data or can be written in a handwritten character in a case of being used as a data set in learning. The symbol is, for example, a symbol indicating an elevator, a fire extinguisher, a fire shutter, or the like. Therefore, in the learning processing of the extraction model, machine learning may be performed to extract a predetermined character or symbol from the architectural drawing data to specify the structure and an extraction position or a type of the divided area. The text data to be included in the data set for learning may be substantially solely the character or the symbol included in the architectural drawing data, or may be separately prepared as data describing various shapes of each structure or features of an installation position of each structure. In addition, by extracting the name or the abbreviation, the information can be deleted from the input map data 12a. In addition, by extracting the type of the divided area, the divided area for setting the waypoint corresponding to the attribute information indicated by the input attribute can be determined.

### Summary of Processing of Present System

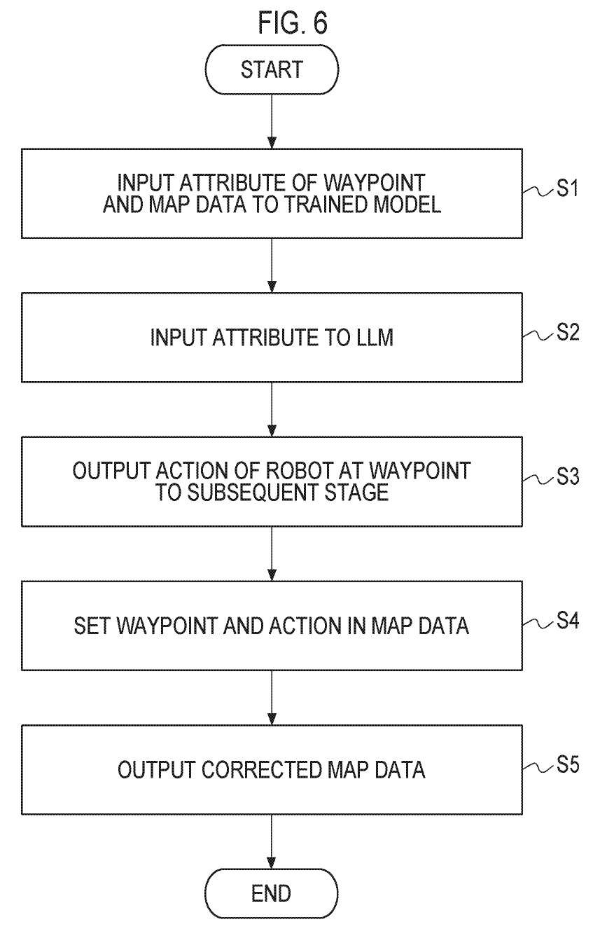

The present disclosure also includes a form of an information conversion method in which the computer corrects and outputs the map data as described above as the processing of the information conversion system 10. The information conversion method will be briefly described with reference to FIG. 6, but various application examples as exemplified as the present system can be applied. FIG. 6 is a flowchart for describing an example of the information conversion method according to the present embodiment.

In the information conversion method, first, the computer exemplified in the information conversion system 10 inputs the input attribute that is the attribute of the waypoint and the map data 12a to the trained model 12b (S1). Next, the computer inputs the input attribute to the LLM 12ba as a part of the calculation in the trained model 12b (S2). Next, the computer executes the calculation in the LLM 12ba to obtain the action of the robot 200 at the waypoint, and outputs the action to the subsequent stage (S3). The output may be executed for each waypoint.

Next, the computer executes the calculation in the LLM 12ba of the trained model 12b in the subsequent stage to set the waypoint and the action in the map data 12a (S4). Next, the computer obtains the corrected map data 12c that is the map data 12a after the setting is made from the trained model 12b, and outputs the corrected map data 12c to the output destination (S5), and the processing ends. For convenience, the calculation in the trained model 12b is divided into the calculation in the LLM 12ba and the calculation in the subsequent stage, but the calculation may be performed simultaneously. The input of the attribute in S1 need not be simultaneous, but the attribute may be input before S2, and the map data 12a may be input before S4.

In addition, the present disclosure also includes a form of a program causing a computer to execute the processing indicated by the information conversion method. In addition, a part or all of the processing in the robot 200, the management apparatus 100, and the like described above can also be realized as a program. Such a program can be stored in various types of non-transitory computer-readable media (storage media) and supplied to a computer. The non-transitory computer-readable medium includes various types of tangible recording media. Examples of the non-transitory computer-readable medium include a magnetic recording medium (for example, a flexible disk, a magnetic tape, and a hard disk drive), a magneto-optical recording medium (for example, a magneto-optical disk), a read only memory (ROM), a CD-R, a CD-R/W, and a semiconductor memory (for example, a mask ROM, a programmable ROM (PROM), an erasable PROM (EPROM), a flash ROM, and a random access memory (RAM)). In addition, the program may be supplied to the computer by various types of temporary computer-readable media. Examples of the transitory computer readable media include electrical signals, optical signals, and electromagnetic waves. The transitory computer readable medium can supply the program to the computer via a wired communication path such as an electric wire and an optical fiber, or a wireless communication path.

### Effects of Present Embodiment

According to the present embodiment, even when the attribute of the waypoint is described and input in different expressions for each user, the attribute described in a fluctuation of the natural language or the attribute described in a plurality of individual languages can be recognized and converted into the action corresponding to the attribute. That is, according to the present embodiment, even when the attribute of the waypoint is described and input in different expressions for each user, it is possible to designate the action at the waypoint. Therefore, according to the present embodiment, the action of the autonomous mobile robot can be easily designated. In addition, according to the present embodiment, the waypoint on which the action designated in this way is set can be automatically set in the map data. In particular, when a large number of waypoints are set in a case of operating the autonomous mobile robot, more detailed control can be performed, but according to the present embodiment, the time and effort required for the setting work can be reduced as compared with a case in which a large number of waypoints on which the action is manually designated are set for the map data, and the efficiency of the setting work can be improved.

### Other Application Examples

The present disclosure is not limited to the embodiment, and can be appropriately modified without departing from the spirit.

For example, the generated map data may be used for a purpose other than the movement of the autonomous mobile object such as the robot 200. In FIGS. 3 to 5, it is assumed that the input map data and the output corrected map data are two-dimensional, but as described for the map data, the data may be three-dimensional data. In the three-dimensional map data, the attribute of the ceiling or the floor can be set as the waypoint, and for example, the attribute of the ceiling with the exhaust port, the ceiling at a predetermined height or less, the floor with the guide light, whether the material of the floor is a predetermined material, and the like can also be set. Therefore, for example, in the waypoint having the ceiling at the predetermined height or less as the attribute, the action such as the passage prohibition can be set according to the height of the robot 200. In addition, in the waypoint having the floor with the guide light as the attribute, the action such as the parking prohibition can be set. In addition, in a case of a robot having an arm, the waypoint and the attribute thereof may be used for controlling a movable range of the arm. In addition, the three-dimensional map data can also be used for the operation of an autonomous flying object that is an autonomous mobile object that flies.

In addition, the trained model 12b or the LLM 12ba or the VLM included in the trained model 12b may be a model that can be retrained. For example, the trained model 12b may include, as the LLM 12ba or the VLM, for example, an open source machine learning model such as retrieval-augmented generation (RaG). As a result, the calculation processing unit 11 can update the trained model based on the latest database. This is because the database can be updated to obtain a more correct output.

What is claimed is:

1. An information conversion system, wherein the information conversion system is configured to
input an input attribute that is an attribute of a waypoint described in natural language to a trained model incorporating a large language model, the waypoint being a candidate for a via point of an autonomous mobile robot that travels in a facility, and
recognize, by the trained model, attribute information indicated by the input attribute among a plurality of types of attribute information indicating the attribute of the waypoint, and output an action of the autonomous mobile robot from the waypoint to an adjacent waypoint that is adjacent to the waypoint, the action corresponding to the attribute information that is recognized.

2. The information conversion system according to claim 1, wherein the information conversion system is configured to input direction information indicating a traveling direction of the autonomous mobile robot to the trained model, and determine, by the trained model, the adjacent waypoint in accordance with the direction information.

3. The information conversion system according to claim 1, wherein the information conversion system is configured to input route information indicating a traveling route of the autonomous mobile robot to the trained model, and determine, by the trained model, the adjacent waypoint in accordance with the route information.

4. An information conversion method executed by a computer, the information conversion method comprising:
inputting an input attribute that is an attribute of a waypoint described in natural language to a trained model incorporating a large language model, the waypoint being a candidate for a via point of an autonomous mobile robot that travels in a facility; and
recognizing, by the trained model, attribute information indicated by the input attribute among a plurality of types of attribute information indicating the attribute of the waypoint, and obtaining an action of the autonomous mobile robot from the waypoint to an adjacent waypoint that is adjacent to the waypoint, the action corresponding to the attribute information that is recognized.

5. A non-transitory storage medium storing a program that causes a computer to execute:
inputting an input attribute that is an attribute of a waypoint described in natural language to a trained model incorporating a large language model, the waypoint being a candidate for a via point of an autonomous mobile robot that travels in a facility; and
recognizing, by the trained model, attribute information indicated by the input attribute among a plurality of types of attribute information indicating the attribute of the waypoint, and obtaining an action of the autonomous mobile robot from the waypoint to an adjacent waypoint that is adjacent to the waypoint, the action corresponding to the attribute information that is recognized.
